(19) United States
(12) Patent Application Publication
(10) Pub. No.: US 2019/0377274 A1
(43) Pub. Date: Dec. 12, 2019

(54) ELECTROPHOTOGRAPHIC PHOTORECEPTOR, METHOD FOR PRODUCING THE SAME, AND ELECTROPHOTOGRAPHIC DEVICE

(71) Applicant: FUJI ELECTRIC CO., LTD., Kawasaki-shi (JP)

(72) Inventors: Shinjiro SUZUKI, Matsumoto-city (JP); Kazuki NEBASHI, Matsumoto-city (JP); Fengqiang ZHU, Matsumoto-city (JP); Toshiki TAKEUCHI, Shen Zhen (CN)

(73) Assignee: FUJI ELECTRIC CO., LTD., Kawasaki-shi (JP)

(21) Appl. No.: 16/549,401

(22) Filed: Aug. 23, 2019

Related U.S. Application Data
(63) Continuation of application No. PCT/JP2018/011866, filed on Mar. 23, 2018.

(51) Int. Cl. G03G 5/06; G03G 15/00

(52) U.S. Cl. CPC G03G 5/0696; G03G 15/75; G03G 5/0675

(57) ABSTRACT

A method for producing an electrophotographic photoreceptor having a conductive substrate, and a photosensitive layer formed on the conductive substrate. The method includes the steps of preparing a coating liquid containing a charge generating material, and applying the coating liquid on to the conductive substrate, to thereby form the photosensitive layer. An absolute value of a zeta potential of the charge generating material is 5 mV or more, and a half-value width of a zeta potential distribution of the charge generating material is 100 mV or less.

### CROSS REFERENCE TO RELATED APPLICATIONS

This is a continuation application of International Application No. PCT/JP2018/011866 filed on Mar. 23, 2018, the contents of which are incorporated herein by reference.

### TECHNICAL FIELD

The present invention relates to an electrophotographic photoreceptor (hereinafter also simply referred to as “photoreceptor”) to be used in a printer, a copying machine, or a fax machine based on an electrophotographic method, a method of producing the same, and an electrophotographic device.

### BACKGROUND ART

An electrophotographic photoreceptor has a basic structure, in which a photosensitive layer having a photoconductive function is placed on a conductive substrate. An organic electrophotographic photoreceptor using an organic compound as a functional component responsible for generation or transport of electric charge has been recently studied actively and come to be used more and more in a copying machine, a printer, etc. in view of advantages of a great diversity of materials, high productivity, safety, etc.

Generally, a photoreceptor requires a function of retaining surface electric charge in a dark place, a function of generating electric charge by receiving light, and a function of transporting the generated electric charge. As such a photoreceptor there are a so-called monolayer photoreceptor provided with a single layer photosensitive layer having all of the above functions, and a so-called laminated (functionally separated) photoreceptor provided with a photosensitive layer which stacks layers functionally separated into a charge generation layer mainly responsible for a function of generating electric charge upon receipt of light and a charge transport layer responsible for functions of retaining surface electric charge in a dark place and transporting electric charge generated in the charge generation layer upon receipt of light.

The photosensitive layer is generally formed by applying a coating liquid, in which a charge generating material, a charge transport material, and a resin binder are dissolved or dispersed in an organic solvent, on a conductive substrate. As a charge generating material used for the photoreceptor, various organic dyes and organic pigments have been proposed. For example, polycyclic quinone pigments, pyrylium dyes, a eutectic complex of pyrylium dye and a polycarbonate, squarylium pigments, phthalocyanine pigments, azo pigments, etc. have been put into practical use. Among these, the phthalocyanine pigment can achieve high sensitivity by giving a specific aggregation structure or crystal structure, and therefore various crystal forms have been proposed. For example, Patent Document 1, Patent Document 2, etc. describe various crystal forms, and various titanyl phthalocyanine pigments have been studied.

Meanwhile, when a layer containing a charge generating material is formed in the organic electrophotographic photoreceptors, it is necessary that the charge generating material is uniformly applied. When an aggregate of the charge generating material is formed, a local difference in the amount of charge generation occurs, which leads to a decrease in the amount of electric charge due to generation of surplus charge and an inflow of electric charge from the conductive substrate, so that a fog or black spot becomes likely to appear.

Further, a phthalocyanine pigment has poor dispersion stability as a coating material, because the pigment particles have a very small particle size, and aggregation or sedimentation of the pigment is likely to occur depending on a resin binder or a solvent used for the coating material, which may cause a coating defect, such as nonuniformity and pigment aggregation at the time of coating to induce deterioration of the properties, such as sensitivity reduction, or image defect. For this reason, in a photoreceptor using a phthalocyanine pigment, tiny black spots may be generated at the time of reversal development to form an image defect. That is, even in a case of an ordinary electrophotographic photoreceptor, the electrical contact between a conductive substrate and a photosensitive layer is not microscopically uniform. For example, the inflow amount of carriers from the side of the conductive substrate differs with location, and consequently there appears local variance in the distribution of electric charges held on the surface of the photoreceptor. This is manifested as an image defect after development, namely as a white spot in the black background in the case of positive development system, and as a black spot in the white background in the case of negative reversal development system. In particular, the black spot in the reversal development system is as troublesome as base fog, because it significantly impairs the image quality. Such a trouble is particularly serious in a high temperature and high humidity environment. In other words, in the high temperature and high humidity environment, the inflow amount of carriers increases due to the influence of humidity, so that innumerable tiny black spots appear like base fog to impair significantly the image quality.

In addition, due to recent development and increase in the penetration rate of a color printer, increase in the printing speed, downsizing of a device, and reduction in number of parts have been advancing, and measures responding to various service environments have been also required. Under such circumstances, demand for a photoreceptor, which image characteristic or electrical properties fluctuate little due to repeated use or variations of service environment (room temperature and environment), has been remarkably strengthening, and full satisfaction of such requirements by a conventional technology has become difficult.

For solving these problems, various methods for improving a photoreceptor have been proposed. For example, Patent Document 3 discloses a technique for preventing fogging at a high temperature and a high humidity using a combination of a specific undercoat layer and charge generating material. Further, Patent Document 4 discloses a technique for improving an image defect by using a specific dispersion condition.

### RELATER ART DOCUMENTS

### Patent Documents

Patent Document 1: JPH01-17066A
Patent Document 2: JPH02-267563A
Patent Document 3: JP4809465B2
Patent Document 4: JP5194553B2

### SUMMARY OF THE INVENTION

### Problems to be Solved by the Invention

As described above, various technologies have been heretofore proposed concerning improvement of a photoreceptor. However, any of the technologies described in the above Patent Documents have been not adequate in terms of image defect, etc. in practical use. In addition, a coating liquid to be used in coating to form a photosensitive layer has not been sufficiently studied, and as a result, further improvement of the coating liquid itself for forming a photosensitive layer including a charge generating material, is necessary in order to develop a photoreceptor with improved image quality.

Under such a situation, an object of the present invention is to provide an electrophotographic photoreceptor, which is free from deterioration of image quality such as black spots attributable to a charge generating material and is able to develop a stable image, as well as a method for producing the same, and an electrophotographic device.

### Means for Solving the Problems

The inventors studied diligently on the charge generating material for the photoreceptor for achieving the object, and have provided as the consequence a photoreceptor, which gives an image with little defects and is stable in image quality even after repetitive use. Specifically, the inventors have found that an excellent electrophotographic photoreceptor may be obtained by adopting a configuration described below, thereby completing the present invention.

That is, a first aspect of the present invention is an electrophotographic photoreceptor comprising:

a conductive substrate; and

a photosensitive layer formed on the conductive substrate, wherein the photosensitive layer contains a charge generating material, and an absolute value of a zeta potential of the charge generating material in a coating liquid for forming a photosensitive layer to form the photosensitive layer is 5 mV or more, and a half-value width of a zeta potential distribution of the charge generating material in the coating liquid for forming a photosensitive layer is 100 mV or less.

The charge generating material preferably includes at least one selected from the group consisting of titanyl phthalocyanine, hydroxygallium phthalocyanine, chlorogallium phthalocyanine, a metal-free phthalocyanine, and a pigment having an azo bond. In addition, an absolute value of electrophoretic mobility of the charge generating material at the time of measuring the zeta potential is preferably 0.01 μm·cm/V·s or more. Further, a dielectric constant of a solvent contained in the coating liquid for forming a photosensitive layer is preferably 30 or less.

A second aspect of the present invention is a method for producing the electrophotographic photoreceptor including steps of:

applying a coating liquid for forming a photosensitive layer on to the conductive substrate to form the photosensitive layer; and

preparing the coating liquid for forming a photosensitive layer containing the charge generating material.

Furthermore, a third aspect of the present invention is an electrophotographic device equipped with the electrophotographic photoreceptor.

### Effects of the Invention

According to the above aspects of the present invention, an electrophotographic photoreceptor, which was suppressed from deterioration of image quality such as black spots attributable to a charge generating material, and capable of realizing a stable image, a method for producing the same and an electrophotographic device were realized.

### BRIEF DESCRIPTION OF THE DRAWINGS

FIG. 1 is a schematic cross-sectional view showing a negatively-charged laminated electrophotographic photoreceptor as an example of the electrophotographic photoreceptor of the present invention.

FIG. 2 is a schematic cross-sectional view showing a positively-charged monolayer electrophotographic photoreceptor as another example of the electrophotographic photoreceptor of the present invention.

FIG. 3 is a schematic cross-sectional view showing a positively-charged laminated electrophotographic photoreceptor as still another example of the electrophotographic photoreceptor of the present invention.

FIG. 4 is a schematic diagram showing an example of the electrophotographic device of the present invention.

### MODE FOR CARRYING OUT THE INVENTION

A specific embodiment of the present invention will be described in detail with reference to drawings, provided that the present invention is not restricted in any way by the following description.

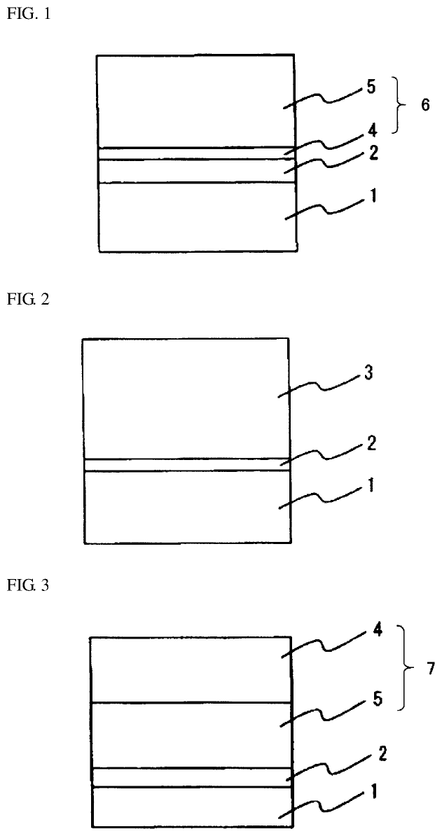

As described above, electrophotographic photoreceptors are roughly classified into so-called negatively-charged laminated photoreceptors and positively-charged laminated photoreceptors, both as laminated (functionally separated) photoreceptors, and monolayer photoreceptors mainly used as a positively-charged type. FIG. 1 is a schematic cross-sectional view showing a negatively-charged laminated electrophotographic photoreceptor as an example of the electrophotographic photoreceptor of the present invention. FIG. 2 is a schematic cross-sectional view showing a positively-charged monolayer electrophotographic photoreceptor as another example of the electrophotographic photoreceptor of the present invention. FIG. 3 is a schematic cross-sectional view showing a positively-charged laminated electrophotographic photoreceptor as still another example of the electrophotographic photoreceptor of the present invention.

As illustrated, in a negatively-charged laminated photoreceptor, on a conductive substrate 1, an undercoat layer 2, and a photosensitive layer 6 having a charge generation layer 4 provided with a charge generating function and a charge transport layer 5 provided with a charge transporting function are sequentially layered one on another. In a positively-charged monolayer photoreceptor, on a conductive substrate 1, an undercoat layer 2, and a monolayer photosensitive layer 3 provided with both a charge generating function and a charge transporting function are sequentially layered one on another. Further, in a positively-charged laminated photoreceptor, on a conductive substrate 1, an undercoat layer 2, and a photosensitive layer 7 having a charge transport layer 5 provided with a charge transporting function, and a charge generation layer 4 provided with both a charge generating function and a charge transporting function are layered one on another. In any type of the photoreceptors, an undercoat layer 2 may be provided according to need.

The photoreceptor of the embodiment of the present invention includes a conductive substrate and a photosensitive layer provided on the conductive substrate, and the photosensitive layer contains a charge generating material. As for the charge generating material, it is important to use one in which an absolute value of a zeta potential is 5 mV or more, and a half-value width of a zeta potential distribution is 100 mV or less in a coating liquid for forming a photosensitive layer for forming the photosensitive layer. In this regard, the half-value width of the zeta potential distribution means a half-value width of a spectrum expressing the intensity on the vertical axis and the zeta potential on the horizontal axis, and the absolute value represents a peak value of the spectrum.

The reason why an electrophotographic photoreceptor, which is suppressed from deterioration of image quality such as black spots attributable to a charge generating material, and capable of realizing a stable image, can be obtained is as follows.

That is, since a charge generating material having a zeta potential with an absolute value of 5 mV or more in a coating liquid for forming a photosensitive layer is used for a photosensitive layer, the repulsive force among particles of the charge generating material dispersed in the coating liquid for forming a photosensitive layer can be increased, and as a result, aggregation of the charge generating material particles in the coating liquid for forming a photosensitive layer can be prevented. By using a charge generating material for photosensitive layer that has a half-value width of the zeta potential distribution in the coating liquid for forming a photosensitive layer of 100 mV or less, the variation in zeta potential among the particles of the charge generating material can be reduced, so that stable dispersion of the charge generating material in the coating liquid for forming a photosensitive layer may be attained, and further aggregation of the charge generating material particles is suppressed even while the coating film of the photosensitive layer is dried. As a consequence, a photoreceptor having superior image quality without black spots can be obtained.

When the absolute value of the zeta potential of the charge generating material is less than 5 mV, the repulsive force among the charge generating material particles is reduced to generate aggregation, which causes black spots. The absolute value of the zeta potential of the charge generating material is preferably 20 mV or more, and may be, for example, from 25 to 80 mV. The larger the value is, the greater the repulsive force among the charge generating material particles becomes, which is preferable.

When the half-value width of the zeta potential distribution of the charge generating material exceeds 100 mV, the particles of the charge generating material having a large difference in zeta potential in a coating liquid or at the time of forming a coating film come to aggregate together causing black spots. The half-value width of the zeta potential distribution of the charge generating material is preferably 50 mV or less, and may be, for example, from 20 to 50 mV. The smaller the value is, the smaller the variation in zeta potential among the charge generating material particles becomes, which is preferable.

The coating film of the photosensitive layer is formed in a solvent vapor atmosphere, and in doing so the coating film is still on the way of drying, and therefore the charge generating material contained in the coating film is movable inside the coating film. Consequently, unless the charge generating material satisfies the requirements relating to the zeta potential and the zeta potential distribution, aggregation of the charge generating material may occur on the way of drying to cause black spots.

Furthermore, as the absolute value of electrophoretic mobility at the time of measurement of the zeta potential of the charge generating material becomes larger, the repulsive force among the charge generating material particles becomes higher, so that aggregation may be suppressed, which is preferable. The absolute value of the electrophoretic mobility of the charge generating material at the time of measuring the zeta potential is preferably 0.01 μm·cm/V·s or more, and more preferably from 0.1 to 1.0 μm·cm/V·s. Although it is difficult to predict the movement of particles in the process of forming a coating film merely by simple measurement of the state of aggregation of the charge generating material in a coating liquid for forming a photosensitive layer with a particle size distribution analyzer, or the like, the present inventors have also found that satisfaction of the above requirements is effective for suppression of the phenomenon of black spots or fogging on an image to be caused by aggregation of the charge generating material in the process of forming a coating film.

In the embodiment of the present invention, the zeta potential can be measured by combining the electrophoresis method and the laser doppler method. This method measures how fast particles move in a liquid when an electric field is applied, namely the velocity of the particles. When the particle velocity and the intensity of the applied electric field are known, the zeta potential can be calculated using two constants of the viscosity and dielectric constant of a sample. When all particles in a suspension liquid composed of a liquid and the particles have a large negative or positive zeta potential, the particles tend to repel each other and aggregation can be suppressed. When the absolute value of the zeta potential of the particles is small, aggregation of the particles cannot be suppressed, and stable dispersion cannot be achieved. The zeta potential is effective in evaluating the status of dispersion, aggregation, ion adsorption, or the like of particles or molecules in the suspension liquid.

In a conventional measurement of a zeta potential, although the measurement was easy when an aqueous solvent with a high polarity was used as the liquid, it was substantially difficult to perform an accurate measurement when an organic solvent with a low dielectric constant was used. Especially, it was difficult to measure the distribution of zeta potentials. In the embodiment of the present invention, with respect to the measurement of the zeta potential, it has become possible to measure the average zeta potential accurately by reversing at a high rate the cycle of the electric field applied to the electrodes in a measurement cell to suppress the electroosmotic flow, and further to analyze the electrophoretic mobility with high resolution by reversing at a low rate the cycle of the electric field to grasp the influence of the electroosmotic flow. By performing a measurement combining the above, it has become possible to measure the zeta potential of particles and the distribution thereof in a low dielectric constant medium such as an organic solvent with a high sensitivity and high resolution which were not attainable in the past.

In this regard, in a case where the photoreceptor of the embodiment of the present invention is a laminated photoreceptor, the charge generation layer 4 is a photosensitive layer containing the charge generating material, and in a case where it is a monolayer photoreceptor, the monolayer photosensitive layer 3 is a photosensitive layer including the above-described charge generation layer. In other words, in the case of a laminated photoreceptor, a coating liquid for forming a charge generation layer functions as the coating liquid for forming a photosensitive layer, and in the case of a monolayer photoreceptor, a coating liquid for forming a monolayer photosensitive layer functions as the coating liquid for forming a photosensitive layer.

There is no particular restriction on the charge generating material used in the embodiment of the present invention, insofar as the zeta potential and the half-value width of the zeta potential distribution when dispersed in the coating liquid for forming a photosensitive layer are within the above range. Specific examples thereof include a pigment having a phthalocyanine skeleton or a pigment having an azo bond. More specifically, the charge generating material preferably contains at least one selected from the group consisting of titanyl phthalocyanine, hydroxygallium phthalocyanine, chlorogallium phthalocyanine, a metal-free phthalocyanine, and a pigment having an azo bond.

Although there is no particular restriction on the particle diameter of the charge generating material, insofar as it satisfies the requirements concerning the zeta potential and the half-value width of the zeta potential distribution, it is preferably from 10 to 2000 nm when dispersed in a coating liquid for forming a photosensitive layer from the viewpoint of coating appearance and electrical properties, and more preferably from 20 to 1000 nm. In this regard, the particles in the coating liquid for forming a photosensitive layer may be in the form of primary particles, or of a cluster formed from several particles.

There is no particular restriction on the solvent used for a coating liquid for forming a photosensitive layer, insofar as it is a solvent generally used for forming a photosensitive layer, and the charge generating material satisfies the requirements concerning the zeta potential and the half-value width of the zeta potential distribution. Preferable examples thereof include tetrahydrofuran (THF), 1,3-dioxolane, tetrahydropyran, methyl ethyl ketone, methyl isobutyl ketone, cyclohexanone, toluene, methylene chloride, 1,2-dichloroethane, chlorobenzene, ethylene glycol, ethylene glycol monomethyl ether, and 1,2-dimethoxyethane. These may be used singly, or in combination, without any limitation thereto.

The solvent to be contained in a coating liquid for forming a photosensitive layer preferably has a dielectric constant of 30 or less. By using a solvent having a dielectric constant of 30 or less, the solubility of a resin used in combination with the charge generating agent can be secured, which is preferable. The dielectric constant of the solvent is more preferably from 2 to 20.

### (Conductive Substrate)

The conductive substrate 1 serves as an electrode of the photoreceptor and also as a support for each layer constituting the photoreceptor, and may be in any of a cylindrical, plate-like, film-like, or similar form. As a material for the conductive substrate 1, a metal, such as aluminum, a stainless steel, and nickel, or a glass, a resin or the like, which surface has received a conducting treatment, may be used.

### (Undercoat Layer)

The undercoat layer 2 is constituted with a layer mainly composed of a resin, or a metal oxide film such as alumite. The undercoat layer 2 is optionally provided for the purpose of adjusting the inflow property of a charge from the conductive substrate 1 to the photosensitive layer, covering defects on the surface of the conductive substrate, enhancing the adhesion between the photosensitive layer and the conductive substrate 1, or the like. Examples of a resin material to be used for the undercoat layer 2 include an insulating polymer, such as casein, poly(vinyl alcohol), polyamide, a melamine resin, and cellulose, and a conductive polymer, such as polythiophene, polypyrrole, and polyaniline. These resins may be used singly or in combination as appropriate. Further, these resins may be used by adding a metal oxide, such as titanium dioxide and zinc oxide.

### [Negatively-Charged Laminated Photoreceptor]

The photoreceptor of the embodiment of the present invention may have any of the layer configurations shown in FIGS. 1 to 3 insofar as the requirements relating to the charge generating material are satisfied. Preferably, the photoreceptor of the embodiment of the present invention is a negatively-charged laminated electrophotographic photoreceptor, in which the charge generating material is contained in the charge generation layer 4. As described above, the photosensitive layer 6 in the negatively-charged laminated photoreceptor has a charge generation layer 4 and a charge transport layer 5.

The charge generation layer 4 in a negatively-charged laminated photoreceptor is formed, for example, by a method to apply a coating liquid in which particles of a charge generating material are dispersed in a resin binder, and receives light to generate charges. It is important for the charge generation layer 4 to have a high charge generation efficiency and at the same time a favorable inflow property of the generated charges into the charge transport layer 5, and is preferable for it to have a low electric field dependence so that the inflow property is good even in a weak electric field.

More specifically, as the charge generation layer, a phthalocyanine compound, such as X-form metal-free phthalocyanine, τ-form metal-free phthalocyanine, α-form titanyl phthalocyanine, Y-form titanyl phthalocyanine, γ-form titanyl phthalocyanine, amorphous titanyl phthalocyanine, hydroxygallium phthalocyanine, chlorogallium phthalocyanine, and ε-form copper phthalocyanine, various azo pigments, an anthanthrone pigment, a thiapyrylium pigment, a perylene pigment, a perinone pigment, a squarylium pigment, a quinacridone pigment, etc. may be used singly or in combination as appropriate, and a suitable substance can be selected corresponding to the light wavelength region of the exposure light source used for image formation. In particular, a phthalocyanine compound can be suitably used. The charge generation layer 4 may be mainly composed of a charge generating material, and a charge transport material or the like may be added thereto for use.

As a resin binder for the charge generation layer 4, a polycarbonate resin, a polyester resin, a polyamide resin, a polyurethane resin, a vinyl chloride resin, a vinyl acetate resin, a phenoxy resin, a poly(vinyl acetal) resin, a poly(vinyl butyral) resin, a polystyrene resin, a polysulfone resin, a diallyl phthalate resin, a polymer or a copolymer of a methacrylate, and the like may be used singly or in an appropriate combination.

The content of a charge generating material in a charge generation layer 4 is favorably from 20 to 80% by mass with respect to the solid content in the charge generation layer 4, and more favorably from 30 to 70% by mass. Meanwhile, the content of a resin binder in the charge generation layer 4 is favorably from 20 to 80% by mass with respect to the solid content in the charge generation layer 4, and more favorably from 30 to 70% by mass. Since the charge generation layer 4 is required only to have a charge generating function, its film thickness is generally from 0.01 to 1 μm, and favorably from 0.05 to 0.5 μm.

The photoreceptor of the embodiment of the present invention may be produced with a coating liquid for forming a photosensitive layer containing an appropriate combination of a charge generating material satisfying the range of the zeta potential and the aforedescribed composition according to the present invention, and a solvent. The coating liquid for forming a photosensitive layer may contain a resin binder in the above range of the composition.

In a negatively-charged laminated photoreceptor, a charge transport layer 5 is composed mainly of a charge transport material, and a resin binder.

As a resin binder for the charge transport layer 5, various polycarbonate resins, such as a polyarylate resin, a bisphenol A type, a bisphenol Z type, a bisphenol C type, a bisphenol A/biphenyl copolymer, and a bisphenol Z/biphenyl copolymer, may be used singly or in a mixture of plural kinds thereof. Further, the same kind of resins with a different molecular weight may be used in a mixture. Besides the above, a polyphenylene resin, a polyester resin, a poly(vinyl acetal) resin, a poly(vinyl butyral) resin, a poly(vinyl alcohol) resin, a vinyl chloride resin, a vinyl acetate resin, a polyethylene resin, a polypropylene resin, an acrylic resin, a polyurethane resin, an epoxy resin, a melamine resin, a silicone resin, a polyamide resin, a polystyrene resin, a polyacetal resin, a polysulfone resin, a polymer of a methacrylate, and a copolymer thereof may be used.

The mass average molecular weight of the resin binder in terms of polystyrene according to GPC (gel permeation chromatography) analysis is favorably from 5,000 to 250,000, and more favorably from 10,000 to 200,000.

As a charge transport material in a charge transport layer 5 various hydrazone compounds, styryl compounds, diamine compounds, butadiene compounds, indole compounds, arylamine compounds, etc. may be used singly or in an appropriate combination. Specific examples of such a charge transport material include the following (II-1) to (II-31) but not limited thereto.

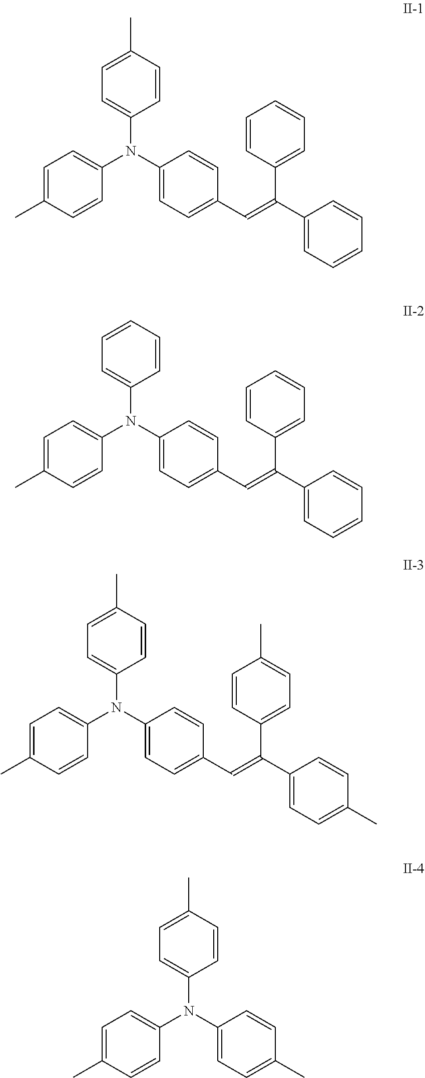

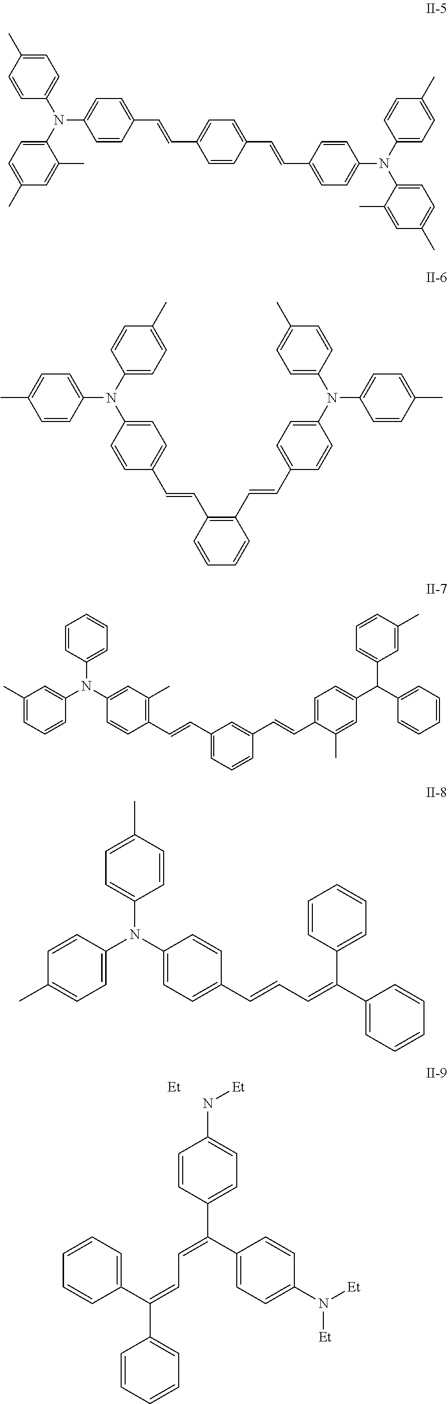

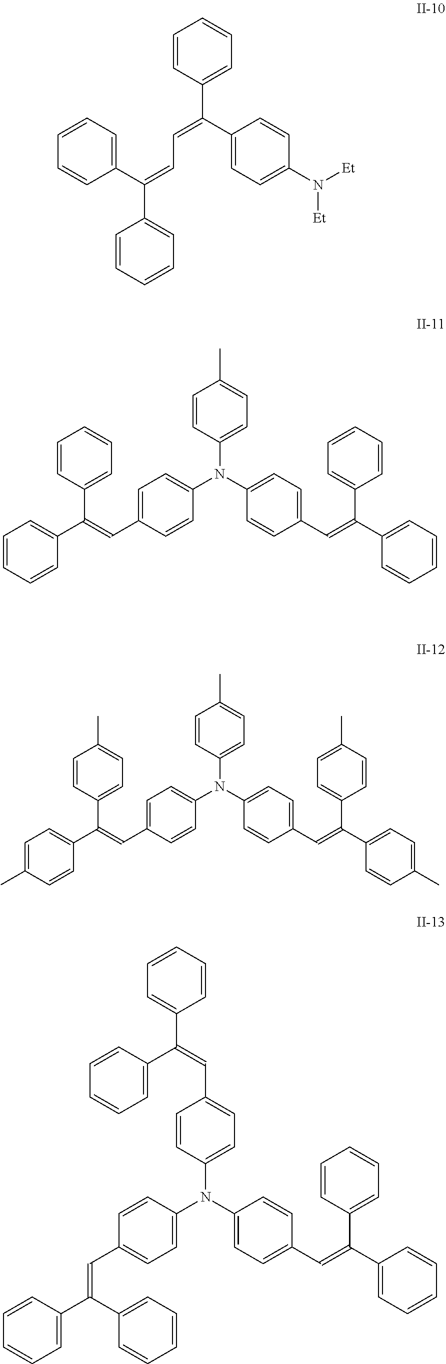

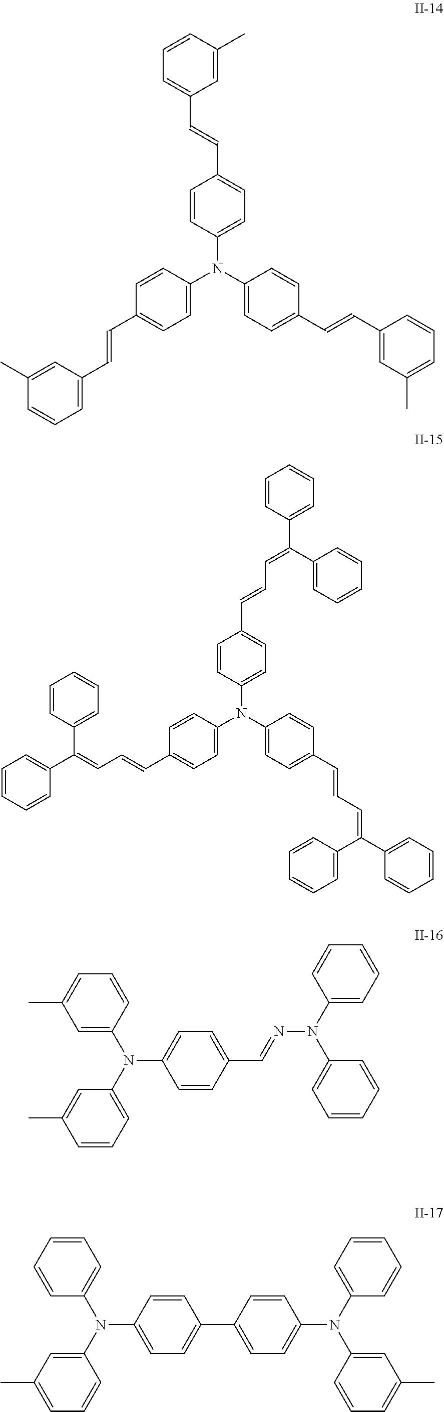

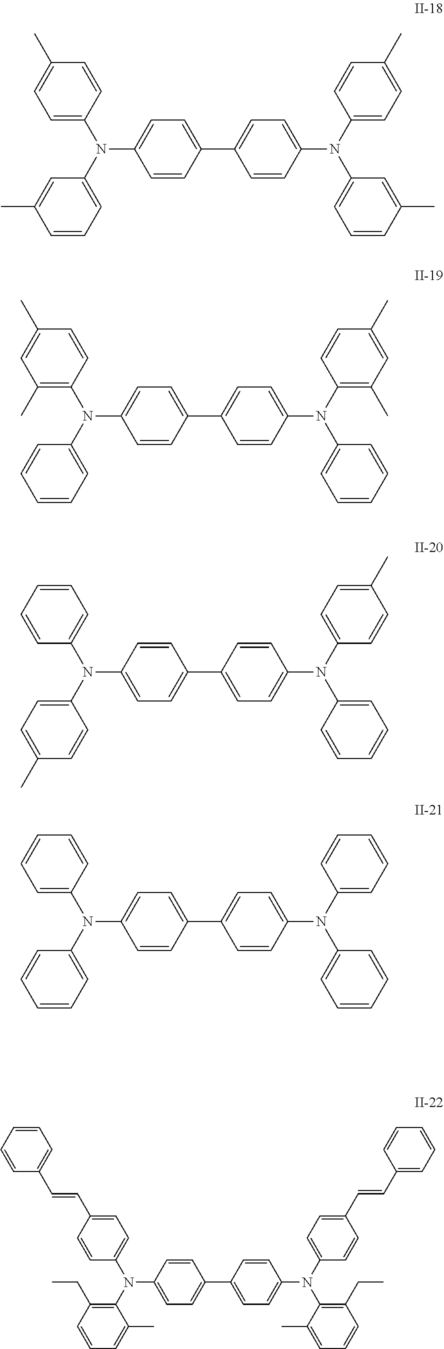

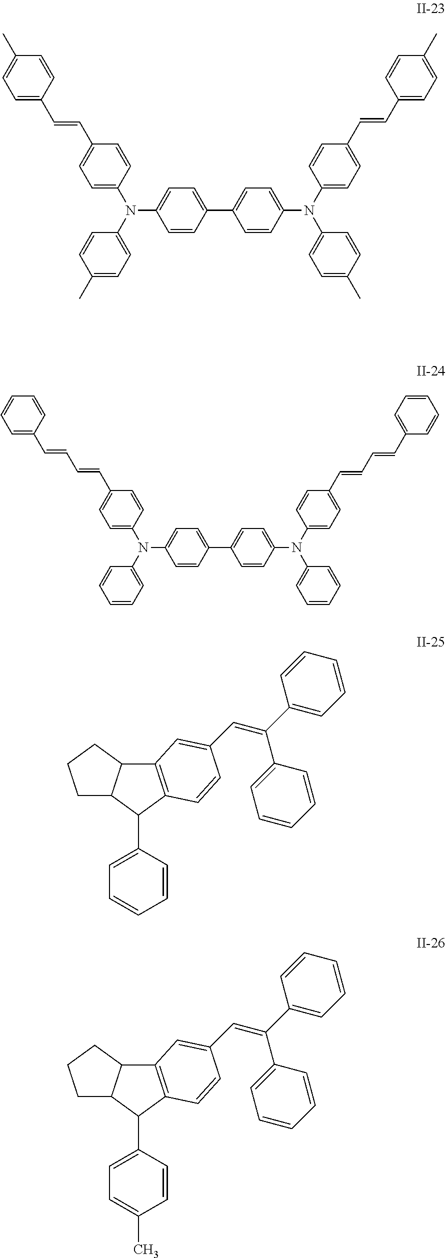

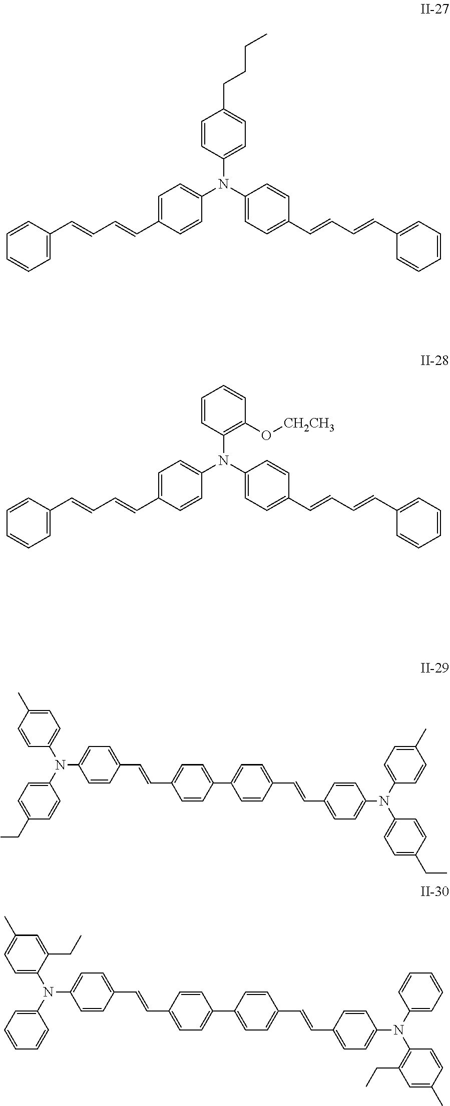 [SMILES: CCCCc1ccc(N(c2ccc(/C=C/C=C/c3ccccc3)cc2)c2ccc(/C=C/C=C/c3ccccc3)cc2)cc1 ; CCOc1ccccc1N(c1ccc(/C=C/C=C/c2ccccc2)cc1)c1ccc(/C=C/C=C/c2ccccc2)cc1 ; CCc1ccc(N(c2ccc(C)cc2)c2ccc(/C=C/c3ccc(-c4ccc(/C=C/c5ccc(N(c6ccc(C)cc6)c6ccc(CC)cc6)cc5)cc4)cc3)cc2)cc1 ; CCc1cc(C)ccc1N(c1ccccc1)c1ccc(/C=C/c2ccc(-c3ccc(/C=C/c4ccc(N(c5ccccc5)c5ccc(C)cc5CC)cc4)cc3)cc2)cc1]

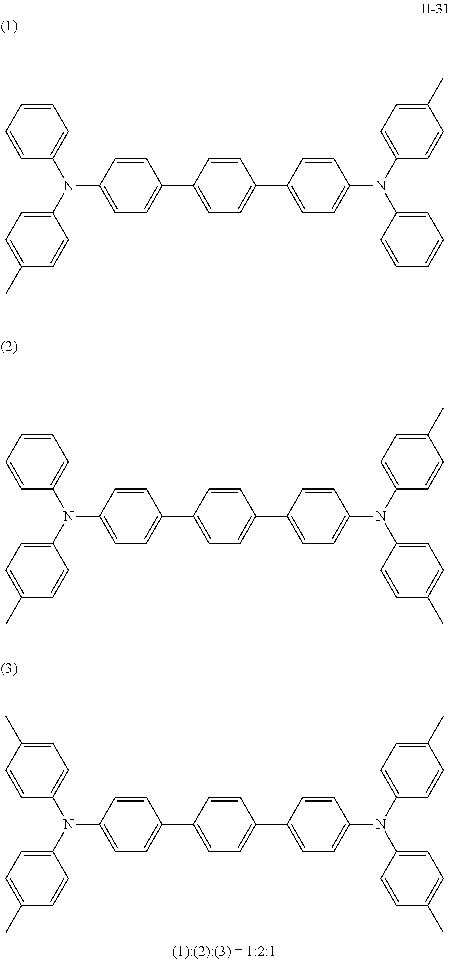 [SMILES: Cc1ccc(N(c2ccccc2)c2ccc(-c3ccc(-c4ccc(N(c5ccccc5)c5ccc(C)cc5)cc4)cc3)cc2)cc1 ; Cc1ccc(N(c2ccccc2)c2ccc(-c3ccc(-c4ccc(N(c5ccc(C)cc5)c5ccc(C)cc5)cc4)cc3)cc2)cc1 ; Cc1ccc(N(c2ccc(C)cc2)c2ccc(-c3ccc(-c4ccc(N(c5ccc(C)cc5)c5ccc(C)cc5)cc4)cc3)cc2)cc1]

The content of a resin binder in a charge transport layer 5 is favorably from 20 to 90% by mass with respect to the solid content of the charge transport layer 5, and more favorably from 30 to 80% by mass. The content of a charge transport material in a charge transport layer 5 is favorably from 10 to 80% by mass with respect to the solid content of the charge transport layer 5, and more favorably from 20 to 70% by mass.

The film thickness of a charge transport layer 5 is preferably in a range of 3 to 50 μm from the viewpoint of maintenance of a surface voltage effective for practical use, and more preferably in a range of 15 to 40 μm.

### [Positively-Charged Monolayer Photoreceptor]

In the case of a positively-charged monolayer photoreceptor a monolayer photosensitive layer 3 is a photosensitive layer containing the charge generating material. In a positively-charged monolayer photoreceptor, a monolayer photosensitive layer 3 is mainly composed of the charge generating material, a positive hole transport material and an electron transport material (acceptor compound) as charge transport materials, and a resin binder.

As a resin binder in a monolayer photosensitive layer 3, various polycarbonate resins, such as a bisphenol A type, a bisphenol Z type, a bisphenol A/biphenyl copolymer, and a bisphenol Z/biphenyl copolymer, a polyphenylene resin, a polyester resin, a poly(vinyl acetal) resin, a poly(vinyl butyral) resin, a poly(vinyl alcohol) resin, a vinyl chloride resin, a vinyl acetate resin, a polyethylene resin, a polypropylene resin, an acrylic resin, a polyurethane resin, an epoxy resin, a melamine resin, a silicone resin, a polyamide resin, a polystyrene resin, a polyacetal resin, a polyarylate resin, a polysulfone resin, a polymer of a methacrylate, and a copolymer thereof may be used. Further, the same kind of resins with a different molecular weight may be used in a mixture.

Specifically, as a charge generating material in a monolayer photosensitive layer 3, for example, a phthalocyanine pigment, an azo pigment, an anthanthrone pigment, a perylene pigment, a perinone pigment, a polycyclic quinone pigment, a squarylium pigment, a thiapyrylium pigment, and a quinacridone pigment may be used. The charge generating materials may be used singly, or in a combination of two or more kinds thereof. Especially, as an azo pigment a disazo pigment, and a trisazo pigment; as a perylene pigment N,N′-bis(3,5-dimethylphenyl)-3,4:9,10-perylene-bis(carboxyimide); as a phthalocyanine pigment a metal-free phthalocyanine, copper phthalocyanine, and titanyl phthalocyanine may be used preferably in a photoreceptor according to the present invention. Further, it is preferable to use X-form metal-free phthalocyanine, τ-form metal-free phthalocyanine, ε-form copper phthalocyanine, α-form titanyl phthalocyanine, Y-form titanyl phthalocyanine, amorphous titanyl phthalocyanine, and titanyl phthalocyanine which shows a maximum peak in a CuKα X-ray diffraction spectrum at a Bragg angle 2θ of 9.6° as described in JPH08-209023, U.S. Pat. Nos. 5,736,282A, and 5,874,570A, hydroxygallium phthalocyanine, or chlorogallium phthalocyanine, because a remarkable improvement effect is exhibited in terms of the sensitivity, durability and image quality.

As a positive hole transport material in a monolayer photosensitive layer 3, for example, a hydrazone compound, a pyrazoline compound, a pyrazolone compound, an oxadiazole compound, an oxazole compound, an arylamine compound, a benzidine compound, a stilbene compound, a styryl compound, poly(N-vinyl carbazole), and polysilane may be used. The positive hole transport materials may be used singly, or in a combination of two or more kinds thereof. As a positive hole transport material to be used according to the present invention, those being superior in transportation capacity for a positive hole generated during light irradiation, and suitable for a combination with a charge generating material are preferable.

Examples of an electron transport material (acceptor compound) in a monolayer photosensitive layer 3 include succinic anhydride, maleic anhydride, dibromosuccinic anhydride, phthalic anhydride, 3-nitrophthalic anhydride, 4-nitrophthalic anhydride, pyromellitic anhydride, pyromellitic acid, trimellitic acid, trimellitic anhydride, phthalimide, 4-nitrophthalimide, tetracyanoethylene, tetracyanoquinodimethane, chloranil, bromanil, o-nitrobenzoic acid, malononitrile, trinitrofluorenone, trinitrothioxanthone, dinitrobenzene, dinitroanthracene, dinitroacridine, nitroanthraquinone, dinitroanthraquinone, a thiopyran compound, a quinone compound, a benzoquinone compound, a diphenoquinone compound, a naphthoquinone compound, an anthraquinone compound, a stilbenequinone compound, and an azoquinone compound. The electron transport materials may be used singly, or in a combination of two or more kinds thereof.

The content of a resin binder in a monolayer photosensitive layer 3 is favorably from 10 to 90% by mass with respect to the solid content of the monolayer photosensitive layer 3, and more favorably from 20 to 80% by mass. The content of a charge generating material in a monolayer photosensitive layer 3 is favorably from 0.1 to 20% by mass with respect to the solid content of the monolayer photosensitive layer 3, and more favorably from 0.5 to 10% by mass. The content of a positive hole transport material in a monolayer photosensitive layer 3 is favorably from 3 to 80% by mass with respect to the solid content of the monolayer photosensitive layer 3, and more favorably from 5 to 60% by mass. The content of an electron transport material in a monolayer photosensitive layer 3 is favorably from 1 to 50% by mass with respect to the solid content of the monolayer photosensitive layer 3, and more favorably from 5 to 40% by mass.

The film thickness of a monolayer photosensitive layer 3 is preferably in a range of 3 to 100 μm from the viewpoint of maintenance of a surface voltage effective for practical use, and more preferably in a range of 5 to 40 μm.

### [Positively-Charged Laminated Photoreceptor]

As described above, a photosensitive layer 7 in a positively-charged laminated photoreceptor has a charge transport layer 5 and a charge generation layer 4. In the case of a positively-charged laminated photoreceptor, a charge generation layer 4 is the outermost layer, and constitutes a photosensitive layer containing the charge generating material. A charge transport layer 5 in a positively-charged laminated photoreceptor is mainly composed of a charge transport material and a resin binder. As such a charge transport material and a resin binder, the same materials as named for a charge transport layer 5 in a negatively-charged laminated photoreceptor may be used. The content of each material and the film thickness of a charge transport layer 5 may be the same as a negatively-charged laminated photoreceptor.

A charge generation layer 4 to be formed on a charge transport layer 5 is mainly composed of the charge generating material, a positive hole transport material and an electron transport material (acceptor compound) as charge transport materials and a resin binder. As a charge generating material, a positive hole transport material, an electron transport material, and a resin binder, the same materials as named for a monolayer photosensitive layer 3 in a monolayer photoreceptor may be used. The content of each material and the film thickness of a charge generation layer 4 may be the same as the monolayer photosensitive layer 3 in a monolayer photoreceptor.

In the embodiment of the present invention, into both of laminated and monolayer photosensitive layers, a leveling agent, such as silicone oil, and fluorinated oil, may be added for the purpose of improvement of the levelling property of a formed film, or impartation of lubricity. Further, plural kinds of inorganic oxides may be added for the purpose of adjustment of film hardness, reduction of friction coefficient, impartation of lubricity, etc. Further, a metal oxide, such as silica, titanium oxide, zinc oxide, calcium oxide, alumina, and zirconium oxide; a metal sulfate, such as barium sulfate, and calcium sulfate; a fine particle of a metal nitride, such as silicon nitride, and aluminum nitride; a particle of a fluorocarbon resin such as a tetrafluoroethylene resin; or a fluorinated comb graft polymer resin may be added. Further, if necessary, another publicly known additive may be added to the extent that electrophotographic characteristics are not significantly impaired.

Further into a photosensitive layer an antidegradant, such as an oxidation inhibitor, and a light stabilizer may be added for the purpose of improvement of environmental resistance, or stability against harmful light. Examples of a compound used for such a purpose include a chromanol derivative and an esterified compound, such as tocopherol, a polyarylalkane compound, a hydroquinone derivative, an etherified compound, a dietherified compound, a benzophenone derivative, a benzotriazole derivative, a thioether compound, a phenylenediamine derivative, a phosphonic acid ester, a phosphite ester, a phenol compound, a hindered phenol compound, a straight chain amine compound, a cyclic amine compound, and a hindered amine compound.

### (Method for Producing Photoreceptor)

The method for producing a photoreceptor of the embodiment of the present invention includes a step of applying a coating liquid for forming a photosensitive layer on to the conductive substrate to form a photosensitive layer in producing the electrophotographic photoreceptor as well as a step of preparing a coating liquid for forming a photosensitive layer containing the charge generating material.

Specifically, in the case of a negatively-charged laminated photoreceptor, firstly a charge generation layer is produced by a method including a step of preparing a coating liquid for forming a charge generation layer, namely the aforedescribed coating liquid for forming a photosensitive layer, by dissolving or dispersing the specific charge generating material and a resin binder in a solvent, and a step of forming a charge generation layer by applying the coating liquid for forming a charge generation layer to the circumference of the conductive substrate, if necessary intercalating an undercoat layer, and drying the same. Next, a charge transport layer is formed by a method including a step of preparing a coating liquid for forming a charge transport layer by dissolving an optional charge transport material and a resin binder in a solvent, and a step of forming a charge transport layer by applying the coating liquid for forming a charge transport layer onto the charge generation layer and drying the same. By such a production method, it is possible to produce the negatively-charged laminated photoreceptor of the embodiment.

In addition, a positively-charged monolayer photoreceptor may be produced by a method including a step of preparing a coating liquid for forming a monolayer photosensitive layer, namely the aforedescribed coating liquid for forming a photosensitive layer, by dissolving or dispersing an optional positive hole transport material, a resin binder, and an electron transport material, as well as the specific charge generating material in a solvent, and a step of forming a photosensitive layer by applying the coating liquid for forming a monolayer photosensitive layer to the circumference of the conductive substrate, if necessary intercalating an undercoat layer, and drying the same.

Furthermore, in the case of a positively-charged laminated photoreceptor, firstly a charge transport layer is formed by a method including a step of preparing a coating liquid for forming a charge transport layer by dissolving an optional charge transport material and a resin binder in a solvent, and a step of forming a charge transport layer by applying the coating liquid for forming a charge transport layer to the circumference of the conductive substrate, if necessary intercalating an undercoat layer, and drying the same. Next, a charge generation layer is formed by a method including a step of preparing a coating liquid for forming a charge generation layer, namely the aforedescribed coating liquid for forming a photosensitive layer by dissolving or dispersing an optional positive hole transport material, a resin binder, and an electron transport material, as well as the specific charge generating material in a solvent, and a step of forming a charge generation layer by applying the coating liquid for forming a charge generation layer onto the charge transport layer and drying the same. By such production methods, it is possible to produce the positively-charged laminated photoreceptor of the embodiment.

In this regard, there is no particular restriction on the type of solvent used for preparing coating liquids, such as the coating liquid for forming a photosensitive layer, coating conditions, drying conditions, etc. and they can be appropriately selected according to the conventional method. Preferably, a dip coating method is used as the coating method. By using the dip coating method, it is possible to produce a photoreceptor having good appearance quality and stable electric characteristics, while securing low cost and high productivity.

In the embodiment of the present invention, examples of a disperser used for dispersing the charge generating material in a coating liquid for forming a photosensitive layer include a paint shaker, a ball mill, and a sand mill without limitation thereto insofar as the requirements of the zeta potential and the half-value width of the zeta potential distribution can be satisfied. In particular, it is preferable to use a circulating bead mill, and more preferable that the vessel volume of the bead mill, the void volume in the vessel, and the retention time of the coating liquid are in desired ranges. Specifically, the ratio (V1/F1) of the void space V1 (L) in the vessel volume to the flow rate F1 (L/min) of the coating liquid at the time of dispersion is preferably in a range of 0.1 to 10.0, and more preferably in a range of 0.2 to 5.0. If the above ratio (V1/F1) is less than 0.1, there is a risk of increase in the dispersion temperature, or excessive dispersion caused by an excessive load. When it exceeds 10.0, it is feared that the retention time may be too short, or a dispersing medium may be unevenly distributed in the vessel, and sufficient dispersion conditions may not be obtained.

### (Electrophotographic Device)

The electrophotographic photoreceptor of the embodiment of the present invention exhibits an intended effect when applied to various machine processes. Specifically, it is able to exhibit a sufficient effect in a charging process, including a contact charging system using a charging member, such as a roller and a brush, and a noncontact charging system using a charging member, such as a corotron, and a scorotron, and also in a developing process, including a contact developing system, and a noncontact developing system, using a developer material, such as a nonmagnetic one component system, a magnetic one component system, and a two component system.

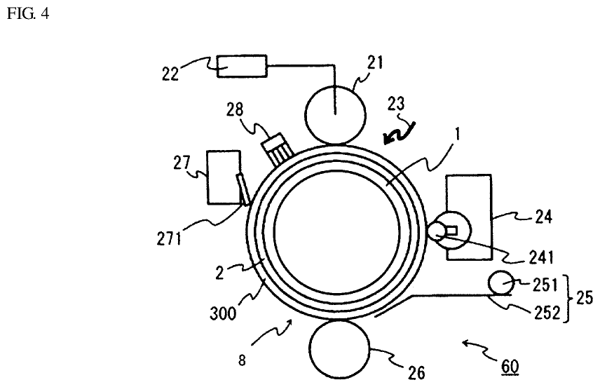

An electrophotographic device of the embodiment of the present invention is constituted by mounting the aforedescribed photoreceptor according to the present invention. The electrophotographic device may include a charging process device and a developing process device. FIG. 4 shows a schematic diagram of a configuration example of an electrophotographic device according to the present invention. The depicted electrophotographic device 60 according to the present invention is equipped with a photoreceptor 8 according to the present invention including a conductive substrate 1, and an undercoat layer 2 and a photosensitive layer 300 coated on the circumference thereof. The electrophotographic device 60 is constituted with a charging member 21 placed at the periphery of the photoreceptor 8; a high-voltage power supply 22 to supply applied voltage to the charging member 21; an image exposure member 23; a developer 24 provided with a developing roller 241; a paper feed member 25 provided with a paper feed roller 251, and a paper feed guide 252; and a transfer charging unit (direct charging type) 26. An electrophotographic device 60 may further include a cleaning device 27 provided with a cleaning blade 271; and a destaticizing member 28. An electrophotographic device 60 may be a color printer.

### EXAMPLES

A specific embodiment of the present invention will be described in more detail by way of Examples. The scope of the present invention is not restricted in any way by the following Examples, unless it departs from the gist of the invention.

### (Production of Negatively-Charged Laminated Photoreceptor)

### Example 1

A coating liquid for forming an undercoat layer was prepared by dissolving or dispersing 5 parts by mass of an alcohol-soluble nylon (Trade name “CM8000”, produced by Toray Industries, Inc.), and 5 parts by mass of titanium oxide fine particles treated with an aminosilane in 90 parts by mass of methanol. The coating liquid for forming an undercoat layer was dip-coated as an undercoat layer on the outer circumference of an aluminum-made cylinder with an outer diameter of 30 mm to be used as a conductive substrate 1, and dried at a temperature of 100° C. for 30 min to complete an undercoat layer 2 with a film thickness of 3 μm.

As a charge generating material 1.5 parts by mass of Y-form titanyl phthalocyanine (Y-TiOPc), and as a resin binder 1 part by mass of a poly(vinyl butyral) resin (Trade name “S-LEC BM-1”, produced by Sekisui Chemical Co., Ltd.) were dissolved in 60 parts by mass of dichloromethane (dielectric constant 9.1). After preparing 5 L of this solution, a circulating bead mill with a vessel volume of 300 mL was filled with 0.64 zirconia beads up to 90% of the vessel volume in terms of bulk volume (void ratio 33%). A coating liquid for a charge generation layer (coating liquid for forming a photosensitive layer) was prepared by circulating the solution at a circulating flow rate of 50 mL/min for 1 hour in the bead mill for dispersion. The ratio (V1/F1) at this time was 2.0. The coating liquid for a charge generation layer was dip-coated on the undercoat layer 2 and dried at a temperature of 80° C. for 30 min to form a charge generation layer 4 having a thickness of 0.3 μm.

As a positive hole transport material (CTM), 8 parts by mass of a compound represented by the following Formula:

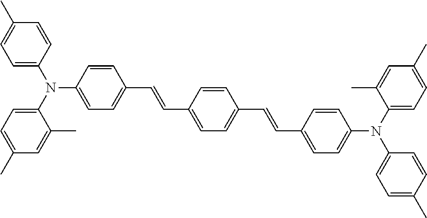 [SMILES: Cc1ccc(N(c2ccc(/C=C/c3ccc(/C=C/c4ccc(N(c5ccc(C)cc5)c5ccc(C)cc5C)cc4)cc3)cc2)c2ccc(C)cc2C)cc1]

and as a resin binder, 12 parts by mass of a resin having a repeating unit represented by the following Formula:

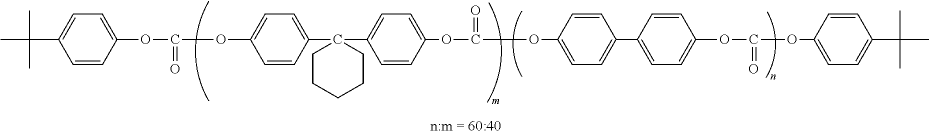

were dissolved in 80 parts by mass of tetrahydrofuran to prepare a coating liquid for forming a charge transport layer. The coating liquid for forming a charge transport layer was dip-coated onto the above charge generation layer 4, and dried at a temperature of 120° C. for 60 min to form a charge transport layer 5 having a thickness of 20 μm to produce a negatively-charged laminated photoreceptor.

### Example 2

A photoreceptor was produced in the same manner as in Example 1 except that the filled volume of the bead mill with the zirconia beads at the time of dispersing the charge generating material in Example 1 was changed to 50% of the vessel volume (void ratio 63%). The ratio (V1/F1) at this time was 4.0.

### Example 3

A photoreceptor was produced in the same manner as in Example 1 except that the vessel volume of the bead mill at the time of dispersing the charge generating material in Example 1 was changed to 1400 mL. The ratio (V1/F1) at this time was 9.2.

### Example 4

A photoreceptor was produced in the same manner as in Example 1 except that the charge generating material used in Example 1 was changed to α-form titanyl phthalocyanine (α-TiOPc).

### Example 5

A photoreceptor was produced in the same manner as in Example 1 except that the charge generating material used in Example 1 was changed to hydroxygallium phthalocyanine (OHGaPc).

### Comparative Example 1

A photoreceptor was produced in the same manner as in Example 1 except that the circulating flow rate at the time of dispersing the charge generating material in Example 1 was changed to 1000 mL/min. The ratio (V1/F1) at this time was 0.099.

### Comparative Example 2

A photoreceptor was produced in the same manner as in Example 3 except that the circulating flow rate at the time of dispersing the charge generating material in Example 3 was changed to 40 mL/min. The ratio (V1/F1) at this time was 11.5.

### Comparative Example 3

A photoreceptor was produced in the same manner as in Example 1 except that the charge generating material in Example 1 was changed to β-form titanyl phthalocyanine. The ratio (V1/F1) at this time was 11.5.

### (Production of Positively-Charged Monolayer Photoreceptor)

### Example 6

A coating liquid for forming an undercoat layer prepared by dissolving with stirring 0.2 parts by mass of a vinyl chloride/vinyl acetate/vinyl alcohol copolymer (Trade name “SOLBIN TASR”, produced by Nissin Chemical Industry Co., Ltd.) in 99 parts by mass of methyl ethyl ketone was dip-coated on the outer circumference of an aluminum-made cylinder having an outer diameter of 24 mm serving as the conductive substrate 1, and dried at a temperature of 100° C. for 30 min to form an undercoat layer 2 having a thickness of 0.1 μm.

As a charge generating material 0.1 parts by mass of an X-form metal-free phthalocyanine (X-H2Pc), as a positive hole transport material 7 parts by mass of the same compound as used in Example 1, as an electron transport material 3.5 parts by mass of a compound represented by the following Formula:

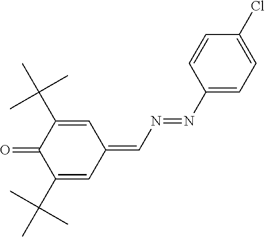 [SMILES: CC(C)(C)C1=CC(=C/N=N/c2ccc(Cl)cc2)C=C(C(C)(C)C)C1=O]

and as a resin binder 8 parts by mass of the same resin as the resin used for the charge transport layer of Example 1 were dissolved in 90 parts by mass of tetrahydrofuran (dielectric constant 11.0) and mixed. After preparing 5 L of this solution, a circulating bead mill with a vessel volume of 300 mL was filled with 1.04 zirconia beads up to 85% of the vessel volume in terms of bulk volume (void ratio 37%). A coating liquid for forming a monolayer photosensitive layer (coating liquid for forming a photosensitive layer) was prepared by circulating the solution at a circulating flow rate of 50 mL/min for 1 hour in the bead mill for dispersion. The ratio (V1/F1) at this time was 2.2. The coating liquid for forming a monolayer photosensitive layer was dip-coated on the undercoat layer 2 and dried at a temperature of 100° C. for 60 min to form a monolayer photosensitive layer 3 having a thickness of 25 μm, thereby completing a monolayer photoreceptor.

### Comparative Example 4

A photoreceptor was produced in the same manner as in Example 6 except that the circulating flow rate at the time of dispersing the charge generating material in Example 6 was changed to 1200 mL/min. The ratio (V1/F1) at this time was 0.093.

### (Production of Positively-Charged Laminated Photoreceptor)

### Example 7

As a resin binder 5 parts by mass of the same resin as the resin used for the charge transport layer of Example 1 and as a positive hole transport material 5 parts by mass of the same compound as used in Example 1 were dissolved in 80 parts by mass of tetrahydrofuran to prepare a coating liquid for forming a charge transport layer. The coating liquid for forming a charge transport layer was dip-coated on the outer circumference of an aluminum-made cylinder with an outer diameter of 24 mm to be used as a conductive substrate 1, and dried at a temperature of 120° C. for 60 min to form a charge transport layer with a film thickness of 15 μm.

As a charge generating material 0.1 parts by mass of Y-form titanyl phthalocyanine, as a positive hole transport material 2 parts by mass of the same compound as used in Example 1, as an electron transport material 5 parts by mass of the same compound as used in Example 6, and as a resin binder 13 parts by mass of the same resin as used for the charge transport layer in Example 1 were dissolved in 120 parts by mass of 1,2-dichloroethane (dielectric constant 10.4) and mixed. After preparing 5 L of this solution, a circulating bead mill with a vessel volume of 300 mL was filled with 1.04 zirconia beads up to 85% of the vessel volume in terms of bulk volume (void ratio 37%). A coating liquid for forming a charge generation layer (coating liquid for forming a photosensitive layer) was prepared by circulating the solution at a circulating flow rate of 50 mL/min for 1 hour in the bead mill for dispersion. The ratio (V1/F1) at this time was 2.2. The coating liquid for forming a charge generation layer was dip-coated on the charge transport layer and dried at a temperature of 100° C. for 60 min to form a charge generation layer having a thickness of 15 μm, thereby completing a positively-charged laminated photoreceptor.

### Comparative Example 5

A photoreceptor was produced in the same manner as in Example 7 except that the circulating flow rate at the time of dispersing the charge generating material in Example 7 was changed to 1200 mL/min. The ratio (V1/F1) at this time was 0.093.

### <Zeta Potential Measurement>

The zeta potential and the half-value width of the zeta potential distribution of the charge generating material in each coating liquid for forming photosensitive layers of Examples 1 to 7 and Comparative Examples 1 to 5 were measured using a Zetasizer Nano ZSP manufactured by Spectris plc. Each coating liquid was diluted 100 times with a solvent used in such each coating liquid, and used as the measurement sample. A measurement of the zeta potential was carried out under two conditions of fast and slow reversal (M3 measurement) using the applied voltage of ±10 V, and DiP cell type electrodes compatible with an organic solvent.

### <Properties in Actual Use>

Each photoreceptor produced in Examples 1 to 5 and Comparative Examples 1 to 3 was mounted on a printer LJ 4250 manufactured by Hewlett Packard, and printing was performed in an environment of high temperature and high humidity (35° C., and 85%). Fogging and black spot on a white sheet were observed. In a case where neither fogging nor black spot was observed, it was rated as good (O), and in a case where fogging and a black spot were observed it was rated as poor (x).

Each photoreceptor produced in Example 6 and 7, and Comparative Example 4 and 5 was mounted on a printer HL-2040 manufactured by Brother Industries, Ltd., and printing was performed in an environment of high temperature and high humidity (35° C., and 85%). Fogging and black spot on a white sheet were observed. In a case where neither fogging nor black spot was observed, it was rated as good (O), and in a case where fogging and a black spot were observed it was rated as poor (x).

The rating results are shown in the following table.

TABLE 1

| | | | Measurement result of zeta potential | | | |
|---|---|---|---|---|---|---|
| | | | | Half-value | | |
| | | | Absolute | width of zeta | | Image |
| | Charge | Charging | value of zeta | potential | Electrophoretic | rating |
| | generating | condition of | potential | distribution | mobility | HH black |
| | material | photoreceptor | (mV) | (mV) | (μmcm/V · S) | spot |
| Example 1 | Y-TiOPc | Negative | 40 | 40 | 0.65 | ∘ |
| Example 2 | Y-TiOPc | Negative | 38 | 45 | 0.53 | ∘ |
| Example 3 | Y-TiOPc | Negative | 30 | 65 | 0.15 | ∘ |
| Example 4 | α-TiOPc | Negative | 35 | 45 | 0.45 | ∘ |
| Example 5 | OHGaPc | Negative | 25 | 70 | 0.35 | ∘ |
| Comparative | Y-TiOPc | Negative | 9 | 110 | 0.008 | x |
| Example 1 | | | | | | |
| Comparative | Y-TiOPc | Negative | 12 | 120 | 0.009 | x |
| Example 2 | | | | | | |
| Comparative | β-TiOPc | Negative | 4 | 48 | 0.008 | x |
| Example 3 | | | | | | |
| Example 6 | X-H₂Pc | Positive | 35 | 50 | 0.21 | ∘ |
| Comparative | X-H₂Pc | Positive | 8 | 130 | 0.111 | x |
| Example 4 | | | | | | |
| Example 7 | Y-TiOPc | Positive | 42 | 40 | 0.08 | ∘ |
| Comparative | Y-TiOPc | Positive | 4 | 115 | 0.09 | x |
| Example 5 | | | | | | |

As shown in the above table, in each Example in which the zeta potential and the half-value width of the zeta potential distribution satisfy the specific ranges, a black spot was not detected in the image to demonstrate that good image quality was obtained.

### DESCRIPTION OF SYMBOLS

1 Conductive substrate
2 Undercoat layer
3 Positively-charged monolayer photosensitive layer
4 Charge generation layer
5 Charge transport layer
6 Negatively-charged laminated photosensitive layer
7 Positively-charged laminated photosensitive layer
8 Photoreceptor
21 Charging member
22 High-voltage power supply
23 Image exposure member
24 Developer
241 Developing roller
25 Paper feed member
251 Paper feed roller
252 Paper feed guide
26 Transfer charging unit (direct charging type)
27 Cleaning device
271 Cleaning blade
28 Destaticizing member
60 Electrophotographic device
300 Photosensitive layer

1. An electrophotographic photoreceptor, comprising:
a conductive substrate; and
a photosensitive layer formed on the conductive substrate by applying a coating liquid containing a charge generating material, an absolute value of a zeta potential of the charge generating material being 5 mV or more, and a half-value width of a zeta potential distribution of the charge generating material being 100 mV or less.

2. The electrophotographic photoreceptor according to claim 1, wherein the charge generating material includes at least one material selected from a group consisting of titanyl phthalocyanine, hydroxygallium phthalocyanine, chlorogallium phthalocyanine, a metal-free phthalocyanine, and a pigment having an azo bond.

3. The electrophotographic photoreceptor according to claim 1, wherein an absolute value of an electrophoretic mobility of the charge generating material at a time of measuring the zeta potential is 0.01 μm·cm/V·s or more.

4. The electrophotographic photoreceptor according to claim 1, wherein the coating liquid is form of a solvent of which a dielectric constant is 30 or less.

5. A method for producing an electrophotographic photoreceptor having a conductive substrate, and a photosensitive layer formed on the conductive substrate, the method comprising steps of:
preparing a coating liquid containing a charge generating material, and
applying the coating liquid on to the conductive substrate, to thereby form the photosensitive layer, wherein
an absolute value of a zeta potential of the charge generating material is 5 mV or more, and a half-value width of a zeta potential distribution of the charge generating material is 100 mV or less.

6. The method of claim 5, wherein the charge generating material includes at least one material selected from a group consisting of titanyl phthalocyanine, hydroxygallium phthalocyanine, chlorogallium phthalocyanine, a metal-free phthalocyanine, and a pigment having an azo bond.

7. The method of claim 5, wherein an absolute value of an electrophoretic mobility of the charge generating material at a time of measuring the zeta potential is 0.01 μm·cm/V·s or more.

8. The method of claim 5, wherein preparing the coating liquid including preparing a solvent of which a dielectric constant is 30 or less.

9. An electrophotographic device equipped with the electrophotographic photoreceptor according to claim 1.
